(19) United States
(12) Patent Application Publication
(10) Pub. No.: US 2021/0035180 A1
(43) Pub. Date: Feb. 4, 2021

(54) UNIFIED RANKING ENGINE FOR A SEARCH SYSTEM

(71) Applicant: eBay Inc., San Jose, CA (US)

(72) Inventors: Moma Chakraborty, Fremont, CA (US); Yi Liu, Campbell, CA (US); Grigor Aslanyan, Oakland, CA (US)

(21) Appl. No.: 16/828,796

(22) Filed: Mar. 24, 2020

Related U.S. Application Data
(60) Provisional application No. 62/881,360, filed on Jul. 31, 2019.

(51) Int. Cl. G06Q 30/06; G06F 16/2457; G06F 16/9535; G06F 16/215; G06Q 30/02; G06N 20/00; G06N 5/04

(52) U.S. Cl. CPC G06Q 30/0629; G06F 16/24578; G06F 16/9535; G06F 16/215; G06N 5/04; G06Q 30/0641; G06Q 30/0631; G06N 20/00; G06Q 30/0282

(57) ABSTRACT

Methods, systems, and computer storage media for providing unified ranking of search result items based on a user-configured ranking attribute for an item listing in an item listing platform. In particular, a unified ranking engine determines a user-configured ranking attribute for an item listing, which is used as part of a boosting model of the unified ranking engine to rank item listings. In operation, an item listing is assigned a boost factor based on the item listing having the user-configured ranking attribute. The boost factor indicates a value that is used to rank the item listing relative to the other item listings of search results item listing. The search result items include a first set of item listings that are promoted listings associated with the user-configured ranking attribute (e.g., promoted-listing ad rates) and second set of listings that are organic listings without user-configured ranking attributes.

### CROSS-REFERENCE TO RELATED APPLICATION

The present application claims priority to U.S. provisional application serial no. 62/881,360, filed Jul. 31, 2019, and titled “UNIFIED RANKING ENGINE FOR A SEARCH SYSTEM,” which is hereby incorporated herein by reference in its entirety.

### BACKGROUND

Users often rely on search systems to help find information stored on computer systems. Such search systems support identifying, for received search queries, search result items from item databases. Users, in particular, use item listing platforms (e.g., e-commerce websites) that support searching to help identify ranked item listings. By way of example, an item listing platform with searching functionality is a critical mechanism that supports identifying items that are listed on the item listing platform. The item listing platform also allows for user submission of items for sale on the item listing platform. Ranked search result items can be provided based on a search query submitted by a user to a search engine of the item listing platform. For example, a text-based search engine can be used to search, rank, and communicate the ranked item listings via an interface for viewing and selecting ranked item listings. Ranking is essential because it efficiently communicates to a searching user the most relevant search result items (i.e., item listings) for a search query.

Conventional item listing platforms can be limited in the manner in which the item listing platforms identify, rank, and present item listings as search query result items. The ranking functionality of conventional item listing platforms is limited, in that, item listing platforms may specifically rely on ranking engines that independently rank search result items. In particular, when items are associated with classifications (e.g., “sponsored listings” or “promoted listings” and “non-sponsored item listings” or “organic listings”), the ranking of promoted listings that are search result items is done separately from ranking of the entire set of search result items.

Independently ranking the promoted listings and the set of search result items results in inefficiencies and ineffectiveness in the ranking engine and the item listing platform search functionality. For example, the ranking engine operates to, for a given search query, firstly rank the promoted listings that are part of the search result items. And, secondly, rank the set of search result items, and then merge the ranked search result items as a ranked search result items set. Ranking promoted listings and the set of search result items in this way further requires allocating fixed slots for promoted listings in the ranked list of search result items. Essentially, item listings in the ranked search result items are duplicated because an item is identified as a promoted listing and also as an organic listing on the same search results page. Moreover, an item listing platform that provides duplicate search result items limits the efficient operation of the item listing platform interfaces and the user experience. With the ever-increasing use of search systems for retrieving electronically stored information, improved search systems can be leveraged to efficiently and effectively rank search result item listings.

### SUMMARY

Various aspects of the technology described herein are generally directed to systems, methods, and computer storage media, for among other things, providing unified ranking of search result items based on a user-configured ranking attribute for an item listing in an item listing platform. For example, a user (e.g., seller) of an item listing platform (e.g., e-commerce website) may list an item for sale (e.g., camera) and then select a user-configured ranking attribute (e.g., a user-selected promoted-listing ad rate) to improve visibility of the item to other users (e.g., buyers) when the item is a search result item for a search query. In particular, a unified ranking engine determines a user-configured ranking attribute for an item listing, the user-configured ranking attribute is used as part of a boosting model of the unified ranking engine to rank item listings. A ranking configuration interface can be provided to receive an input for the user-configured ranking attribute for an item listing that a user has identified as a promoted listing. The item listing is assigned a boost factor based on the item listing having a user-configured ranking attribute. The boost factor indicates a value that is used to rank the item listing relative to the other item listings of search result items. Additionally, the boost factor can be used combination with one or more of a plurality ranking attributes (e.g., listing-quality ranking attributes or features) to rank item listings. As such, the ranking of the item listings can be described as a combined or a unified ranking based on ranking attributes that include listing-quality ranking attributes and the user-configured ranking attribute.

In operation, a ranking configuration interface is provided to receive an input for a user-configured ranking attribute. For example, a seller may submit an item for listing on an item listing platform, and the seller can identify the item as a promoted listing (e.g., a user-selected promoted listing ad rate “ad rate”). Based on the item listing having the user-configured ranking attribute, the item listing is assigned a boost factor. The boost factor indicates a value that is used to rank the item listing relative to the other item listings of search results item listing. For example, the boost factor can correlate with the ad rate, where the boost factor is a weight for ranking the item listing when the item listing is a search result item for a search query. As such, the search result items can include a first set of item listings that are promoted listings associated with the user-configured ranking attribute (e.g., ad rate) and second set of listings that are organic listings without user-configured ranking attributes (e.g., no ad rates) that are ranked and presented on a search result page. Additional ranking attributes (e.g., listing-quality ranking attributes) can be used in combination with the boost factor in ranking.

Accordingly, the embodiments described herein address the above-described issues of independent ranking of item listings by providing unified ranking of search result items on a graphical user interface (GUI). In particular, providing the unified ranked search result items is based on a user-configured attribute that indicates a boost factor that allows an item listing with a user-configured ranking attribute to be ranked in combination with other item listings in the search result items. With the unified ranked search result items, the search result items are presented without duplicates (i.e., the same item listing is not provided as a promoted listing and an organic listing on the same search result page) and the user does not have to review duplicate search result items. In this way, promoted listings can be more efficiently identified and more effectively displayed based on a unified ranking of search results item listings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary item listing platform with a unified ranking engine, in which embodiments described herein may be employed;

FIG. 2 is an illustration of an example item listing platform interface for a unified ranking engine in accordance with aspects of the technology described herein;

FIGS. 3A-3B are illustrations of example offline training operations results for a unified ranking engine in accordance with aspects of the technology described herein;

FIGS. 4A-4D is are illustrations of example item listing platform user ranking experiences, in accordance with aspects of the technology described herein;

FIG. 5 provides a first example method of providing unified ranking operations, in accordance with aspects of the technology described herein;

FIG. 6 provides a second example method of providing unified ranking operations, in accordance with aspects of the technology described herein; and

FIG. 7 is a block diagram of an example computing environment suitable for use in implementing aspects of the technology described herein.

### DETAILED DESCRIPTION

### Overview of Aspects of the Technical Problem, Technical Solution, and Technological Improvement

Search systems support identifying, for received queries, query result items from item databases. Item databases can specifically be for content platforms or item listing platforms such as EBAY content platform, developed by EBAY INC., of San Jose, Calif. An item listing on an item listing platform (e.g., an e-commerce website) can be populated with attributes relating to an item. Item listings are provided as search result items for search queries, where the item listings are ranked based on listing-quality ranking attributes. For example, “iPhone 7” on an item listing platform would be associated with a set of listing-quality ranking attributes (i.e., certain characteristics, specifications, and condition of the “iPhone 7”) that are used to rank the iPhone 7 relative to other search result items for a search query. The “iPhone 7” may also be a promoted item in that a seller has selected the item to have increased visibility on a search result page when the item is identified as a search result item for a search query.

By way of background, a search system (e.g., search platform or item listing platform search system) can be used to systematically search for information (e.g., item listings). The search results (i.e., search result items) are generally presented in a listing of search result items that are ranked. Ranking is essential because it efficiently communicates to a searching user the most relevant search result items. In addition, an item-provider user (e.g., a seller) who has an item listing on the item listing platform may want the item to be seen more prominently seen by searching users (e.g., buyers). The ranking of item listings is further essential because the item listing platform can operate efficiently in that the item listing platform provides the searching user with the most relevant items stored on the item listing platform. And with the item listing platform operating efficiently, sellers can have their item listings shown to buyers, so the buyers can buy the items of the item listings. This discovery process can be facilitated by a ranking engine.

A ranking engine can refer to an implementation of a ranking algorithm used to rank item listings in an item listing platform. There are several different types of ranking techniques that can be implemented in a ranking engine to order search result items on a search result page. By way of example, a search system can store different types of items with different attributes (e.g., classifications, listing-quality rankings attributes) that are used in ranking the items. A classification for items can indicate that the item is a promoted listing or an organic listing (non-sponsored listing, not-promoted items). Items classified as promoted listings (or sponsored listings) generally refer to items that are specifically identified to encourage presentation of the item as a search result item. Promoted listings allow sellers to gain extra visibility by paying an additional fee when listing an item on the item listing platform. The promoted listing may be promoted in that the promoted listing is advanced in rank, position, advertised, or made publicly available or visible in a ranked set of items. In this way, the promoted listing can be an item that is highlighted as a search result item to cause the sale of the item. Organic listings can refer to items are that are not promoted. Organic listings can be searched and identified in search result pages without any additional highlighting and promotion as a search result item.

Independently ranking the promoted listings and the set of search result items causes inefficiencies and ineffectiveness in the ranking engine and the item listing platform search functionality. For example, because the promoted listing items are ranked, followed by ranking the set of search result items, ranking is essentially done twice. One common practice includes allocating fixed slots for promoted listing in search result items, where the promoted listings are ranked independently of the organic listings and placed in the fixed slots in the ranking of search result items. Moreover, the ranked set of promoted listings and the ranked set of search result items are merged, as such, the promoted listings are duplicated when presented on the search results page because the promoted listings are part of the both the set of promoted listings and the set of search result items. Essentially, item listings in the ranked search result items are duplicated in that an item listing is identified as a promoted listing and also as an organic listing on the same search results page. An item listing platform that provides duplicate search result items limits the efficient operation of the item listing platform interfaces and the user experience.

Also, the search result items may include, for some queries, lower relevance and quality of listings because the promoted listings have low listing-quality ranking attributes and the promoted listings still get their allocated fixed slots, which results in poor buyer experience. Further, having fixed slots may lead to missed opportunities where there may be more good quality promoted listings matching the query than the allocated fixed slots, and some good quality promoted listing are not shown. As such, an alternative approach for providing ranking of search result items that include both promoted listings and organic listings would improve computing operations for more efficiently and effectively identification and display of search result items.

Embodiments of the present invention are directed to simple and efficient methods, systems and computer storage media, for among other things, providing unified ranking of search result items, based on a user-configured ranking attribute for an item listing in an item listing platform. For example, a user (e.g., seller) of an item listing platform (e.g., e-commerce website) may list an item for sale (e.g., camera) and then select a user-configured ranking attribute (e.g., e.g., a user-selected promoted listing ad rate) to improve visibility of the item to other users (e.g., buyers) when the item is a search result item for a search query. In particular, a unified ranking engine determines a user-configured ranking attribute for an item listing, the user-configured ranking attribute is used as part of a boosting model of the unified ranking engine to rank item listings. A ranking configuration interface can be provided to receive an input for the user-configured ranking attribute for an item listing that a user has identified as a promoted listing. The item listing is assigned a boost factor based on the item listing having a user-configured ranking attribute. The boost factor indicates a value that is used to rank the item listing relative to the other item listings of search result items. Additionally, the boost factor can be used combination with one or more of a plurality ranking attributes (e.g., listing-quality ranking attributes or features) to rank item listings. As such, the ranking of the item listings can be described as a combined ranking or a unified ranking based on ranking attributes that include listing-quality ranking attributes and the user-configured ranking attribute.

In operation, a ranking configuration interface is provided to receive an input for a user-configured ranking attribute. For example, a seller (e.g., user or item-provider user) may submit an item for listing on an item listing platform, and the seller can identify the item as a promoted listing (e.g., a user-selected promoted listing ad rate “ad rate” or “promoted listing ad rate”). Based on the item listing having the user-configured ranking attribute, the item listing is assigned a boost factor. The boost factor indicates a value that is used to rank the item listing relative to the other item listings of search results item listing. For example, the boost factor can correlate with the ad rate and the boost factor is a weight for ranking the item listing, when the item listing is a search result item for a search query. As such, the search result items can include a first set of item listings that are promoted listings associated with the user-configured ranking attribute (e.g., ad rate) and second set of listings that are organic listings without user-configured ranking attributes (e.g., no ad rates) that are ranked and presented on a search result page. Additional ranking attributes (e.g., listing-quality ranking attributes) can be used in combination with the boost factor in ranking.

Embodiments of the present invention can be further described with reference to an example item listing platform. Aspects of the technical solution described in the present disclosure are directed towards improving ranking of search result items using a unified ranking engine having a boost model in the item listing platform. By way of example, a seller interface (e.g., a ranking configuration interface) can be provided for listing an item as a promoted listing on an item listing platform. For example, a seller interface can provide listing features including tools that support selling activities, sales information, listing guidance, and creating listing. A seller can create a listing by describing the items, adding photos, selecting the brand and physical details about the item. The seller can further choose whether to use the auction or fixed price format and set a price. The seller via the seller interface can elect to sell the item as a promoted listing. A promoted listing can be a classification of an item such that the item can be made more visible to buyers when buyers are browsing and searching for item listings on the item listing platform.

By way of context, an item listing platform can include different types of classifications of items listing stored on the item listing platform. For example, the classifications may be promoted listings or organic listings; other variations and combinations of classifications are contemplated with embodiment described herein. An item listing can be designated as a promoted listing. The item listing may be designated as a promoted listing based on an indication from the seller. By way of example, a promoted listing, for can be an item a sponsored listing. A promoted listing is associated with an ad rate. An ad rate can generally refer to quantified value associated with making a promoted listing more visible in search result items over an organic listing. For example, an ad rate can refer to a percentage of the item's final sale price that is paid to the item listing platform provider upon sale of the item. Or an ad rate can refer to an increased ad rate used in the item listing platform. As such, the ad rate helps the sale potential of a promoted item by improving the chances of your ads being shown more often. A seller can opt to have their item have an increased ad rate. A seller may be charged an ad rate only if a sale is made because of the ad rate. When the ad rate for an item listing is a promoted-listing ad rate, the item listing is designated as a promoted listing.

The item listing platform can use several different ranking techniques providing ordered search result items. For example, ranking can include assigning a numerical weight to each item for the purpose of measuring the relative importance of the item within a set of items. A ranking algorithm can be applied to a set of items based on ranking attributes (e.g., listing- quality ranking attributes) associated with the ranking algorithm. Ranking attributes can include internal attributes (e.g., features of the item) and external attributes (e.g., features of a seller of the item). Ranking algorithms can be used to develop ranking models that are used for retrieving item listings. As discussed herein, the unified ranking engines addresses limitation with conventional ranking algorithms that separately rank promoted listings and organic listings. In addition to addressing such limitations, the unified ranking engine also manages trade-offs between seller and buyer experience—sellers are interested in visibility and sales while buyers care about quality and relevance. The unified ranking engine also support implementing multiple optimizations goals (including improving relevance of listings, quality, and conversion, because while a search engine may easily win short-term revenue by allocating more top slots for sponsored content, this can lead to decreases in organic listings and poor buyer experience.

Embodiments of this invention can be described by way of an example implementation. In particular, the implementation can include a unified ranking engine that ranks both organic listings and promoted listings in a combined manner. The unified ranking engine does not rank the promoted listings independently nor does the unified ranking engine assign fixed slots in the search result page. At a high level, the unified ranking engine assigns a score (“unified ranking score) to each item (organic or promoted) and ranks them using the single unified ranking score. The unified ranking engine can include existing functionality of a conventional machine learning model (e.g., Best Match ranker) that accounts for relevance, popularity, quality, and completion of a listing to show (collectively referred to herein as “listing-quality ranking attributes”) the most desirable listings for buyers. The unified ranking engine can be implemented to balance the trade-off between seller and buyer experience, and take in consideration multiple optimization goals, including relevance, quality, conversion, and revenue. Since the Best Match ranker has already been tuned to target multiple optimization goals (including those listed above) the unified ranking engine can be built as part of the Best Match ranker. For example, the promoted listing score can get the same score from the Best Match ranker, except for an additional boost. For example, the organic listings and promoted listings can be ranked in the top 5 slots of a search results page. With ranking the promoted listings in combination with the organic listings, the unified ranking engine supports optimizing for several additional variables.

The unified ranking engine supports boosting a first set of item listings (i.e., promoted listings) over a second set of item listings (i.e., organic listings) that are identified as search result items for a search query. Promoted listings can have an ad rate that indicates that the promoted listing should be boosted in unified ranking with organic listings. The ranking is boosted based on a boost factor. The boost factor can be determined as a function of the ad rate and any of the following parameters: relevance of an item listing to a search query, quality of the item, conversation rate, and ad rate. Based on using the unified ranking engine to rank the search result items, promoted listings can now be dynamically placed based on an identified rank or additional display rules for presenting promoted listings.

Moreover, ranking techniques can be used to develop a unified ranking engine ranking model (“boost model”). For example, machine learning can also be used as a technique for developing the boost model. Training data can include lists of items with some partial order specified between items in each list. The purpose of the unified ranking model is to rank (i.e., produce a permutation of items in new, unseen lists in a way which is similar to rankings in the training data in some sense) item listings. Training data consists of queries and items matching them together with relevance of each match. Training data can be prepared manually by human assessors, who check results for some queries and determine relevant of each result. Such ranking techniques can be implemented in a conventional ranking model (e.g., associated with the Best Match ranker) that ranks different classifications of item listing independently.

The boost model is specifically a ranking model that increases rankings of promoted listing items based on corresponding values of the boost factor. Item listings can be associated with a boost factor. The boost factor indicates a value that is used to rank an items listing relative to search result items. The search result items include a first set of item listings that are promoted listings associated with promoted-listing ad rates, and a second set of item listings that are organic listings associated with no ad rates. In this regard, the item listing can include the boost factor as an attribute that is used by a ranking engine to perform ranking. For example, a first item listing can have a first boost factor and a second item listing can have a second boost factor. If both the first item listing and the second item listing are identified as search result items, they will both will be boosted in the rankings based on their boost factor. More specifically, they are ranked in an integrated manner relative a set of search result items that are organic listings. In one implementation, organic item listings have a boost factor value (e.g., boost multiplier=1) as well, however, the boost model does not increase the ranking in that the boost factor operates an indicator to not increase the ranking of the organic listing.

A ranked set of search result items can have both boosted rankings of promoted item listings and non-boosted rankings of organic listings using the boost model. The ranked set of search result items avoids duplicates in ranked search result items, based on the unified ranking engine. The ranked set of search result items can be communicated to a search interface on a client device. The ranked search result items are communicated for display on a search interface, where the search result items are not displayed on more than one ranking level of the search interface. Moreover, promoted listings can now be dynamically placed based on identified rank or additional display rules for presenting promoted listings. For example, the first five search result items may be promoted listing items for a first search query, while for a second query, promoted listing may be strategically placed in other positions to improve their placement relative to organic listings. As such, promoted listings can be more efficiently identified to a searching user and more effectively displayed based on the integrated or combined ranking of the search result items using a single ranker of the unified ranking engine.

An offline simulation (and online metrics) can be used to evaluate a promoted listing to determine a value for a boost factor that can be used. The offline simulation includes evaluating promoted listing exposure and promoted listing attributes. The boost factor value is a balance between identifying high quality promoted item listings and having a number of promoted listing for a query. In particular, the unified ranking engine can be designed to provide: better quality of promoted listings and a higher interaction rate with the promoted listings; better overall user experience as measured by overall clicks, conversions, and Gross Merchandise Bought (GMB); and a higher revenue from promoted listings. In this way, the unified ranking engine also manages trade-offs between seller and buyer experience—sellers are interested in visibility and sales while buyers care about quality and relevance.

Embodiments of the present invention have been described with reference to several inventive features (e.g., operations, systems, engines, and components) associated with a search system having a unified ranking search engine. Inventive features described include: operations for providing unified ranking of search result items based on a user-configured ranking attribute for an item listing in an item listing platform. In particular, a unified ranking engine determines a user-configured ranking attribute for an item listing, which is used as part of a boosting model of the unified ranking engine to rank item listings. Functionality of the embodiments of the present invention have further been described, by way of an implementation and anecdotal examples, to demonstrate that the operations for providing unified ranking of search result items are an unconventional ordered combination of operations that operate with a unified ranking engine as a solution to a specific problem in search technology environment to improve computing operations and user interface navigation in item listing and search systems. Overall, these improvements result in less CPU computation, smaller memory requirements, and increased flexibility in search systems.

Overview of Example Environments for Providing an Item Listing Platform with a Unified Ranking Engine

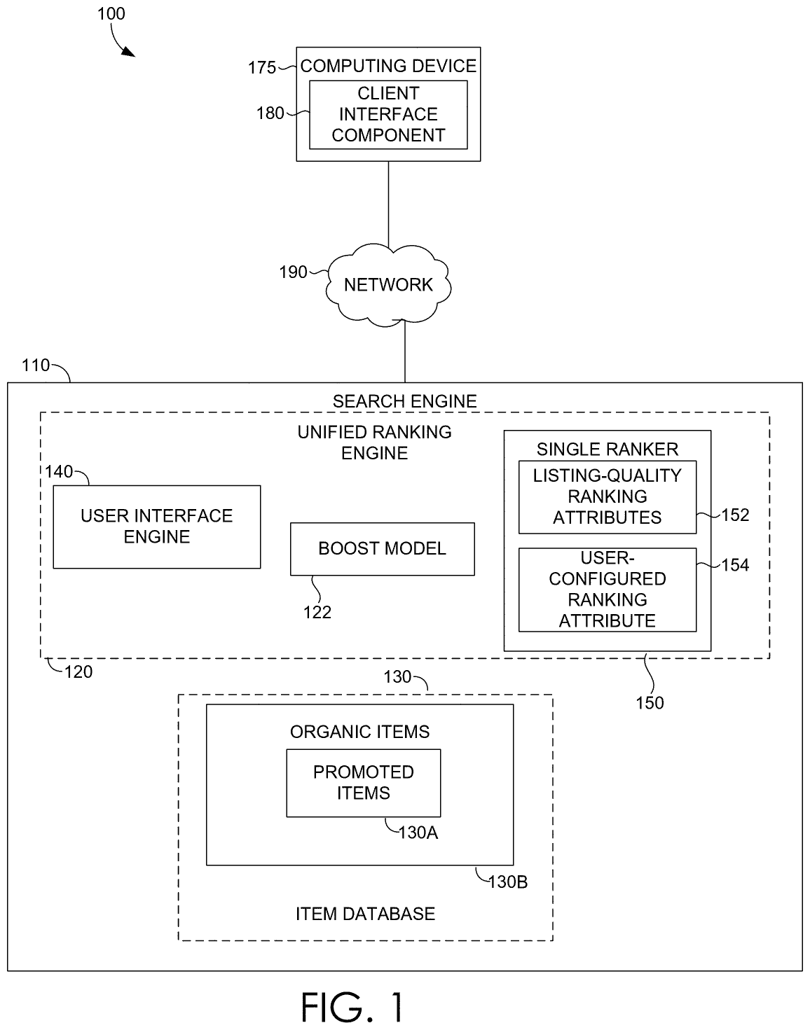

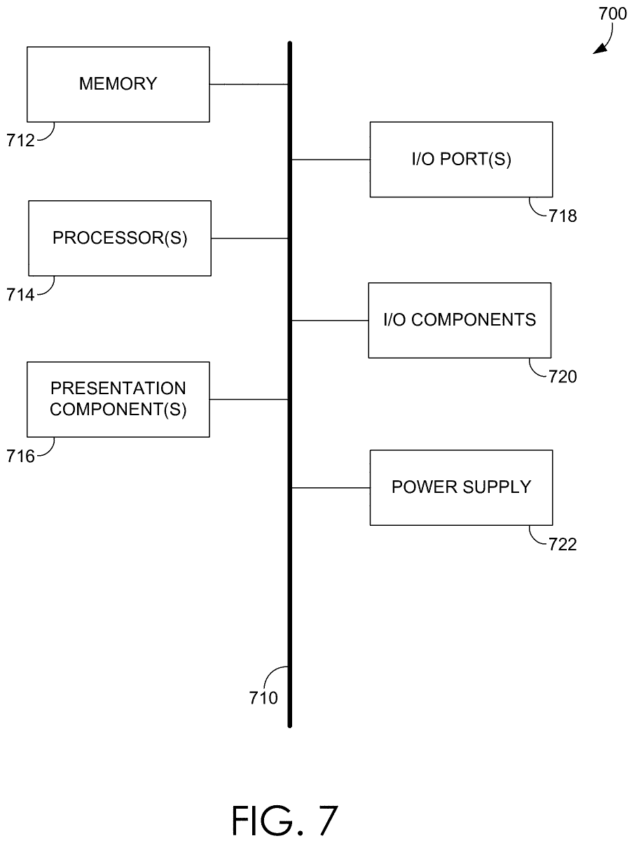

Aspects of the technical solution can be described by way of examples and with reference to FIGS. 1-6. With reference to FIG. 1, FIG. 1 illustrates an example technical solution (i.e., item listing platform 100) in which implementations of the present disclosure may be employed. In particular, FIG. 1 shows a high level architecture of the item listing platform 100 having components in accordance with implementations of the present disclosure. The technical solution environment includes a search engine 110, unified ranking engine 120, item database 130 (including promoted items 130A and organic items 130B), user-configured ranking input interface 140, single ranker 150 (including quality ranking attributes and user-configured ranking attribute 154), computing device 175 (including client interface component 180) and network 190. The components of the search system 100 may communicate with each other over one or more networks (e.g., public network or virtual private network “VPN”) as shown with network 190. The network 190 may include, without limitation, one or more local area networks (LANs) and/or wide area networks (WANs). The computing device 170 may be a client computing device that corresponds to the computing device described herein with reference to FIG. 7.

The components of the item listing platform can operate together to provide functionality for providing unified ranking operations for an item listing platform. As discussed herein, the unified ranking engine 120 is responsible for providing novel operations, components, engines, and interfaces that support ranking item listings in the item listing platform 100. In particular, the unified ranking engine 120 includes user interface engine 140 that supports communicating information that is used to cause display of an interface for receiving the user-configured ranking attribute and also cause display of search result items identified and ranked using the unified ranking engine 120. For example, the user interface engine 140 can support user interfaces for listing items as promoted listings (i.e., promoted items to be classified as promoted listings) or causing display of promoted listings on search results pages in accordance with the embodiment described herein.

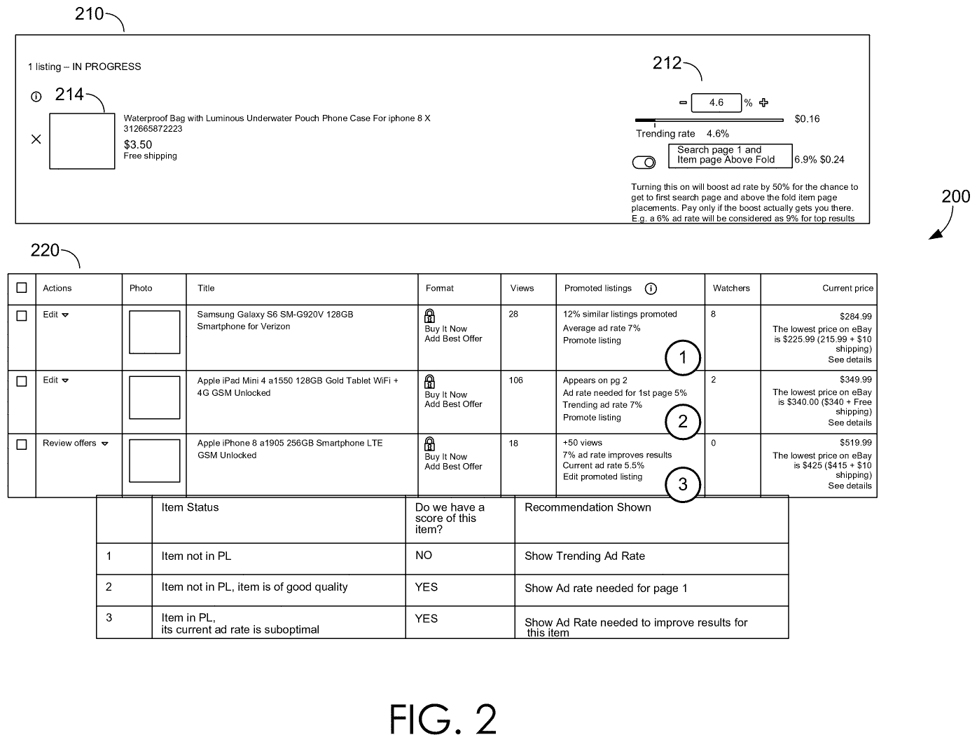

With reference to FIG. 2, FIG. 2 is an example item listing interface (i.e., ranking configuration interface 200) that can be configured to support displaying unified ranking interface data. In particular, the unified ranking interface data can include information to support classifying an item as a promoted listing (e.g., a “potential promoted listing”) and cause display of information for active listings (e.g., “active listings” or “promoted active listings”). For example, the user interface engine 140 can support a potential promoted listing calibration interface portion 210 (or widget) and an active listings portion 220 (or widget). By way of example, in one embodiment, the potential promoted listing calibration portion 210 can allow a user to enter an ad rate 212 for a selected item listing 214. Among other functionality possible for the potential promoted listing calibration portion 210, several interface elements may support selecting the particular ad rate (e.g., an input indicator that can be quickly increased or decreased). The potential promoted listing calibration portion 210 can also include potential promoted listing configuration data (e.g., trending ad rate for the particular product) and potential promoted listing configuration data. The promoted listing calibration portion 210 can also include a potential promoted listing recommendation for a different ad rate (e.g., increase add rate from 4.6% to 6.9%).

With continued reference to FIG. 2, the ranking configuration interface 200 can also include an active listings calibration portion with a set of user selection features, configuration data, and recommendation data. By way of example, in one embodiment, the active listings calibration portion 220 includes a listing of active listings (i.e., 1, 2, and 3). Each active listing can be associated with configuration data (e.g., “Item is a promoted listing”, or “Item is not a promoted listing”), recommendation data (e.g., “show trending ad rate”, “show ad rate needed for page 1”, and “show ad rate needed to improve results for this item”). As such, it is contemplated that the recommendation for the ad rate can be provided based on the specific intended location of the item listing in the search results page. Other variations and combinations of user selection features, configuration data, and recommendation data are contemplated with embodiments described here. Upon providing the ranking configuration interface 200, a user-configured ranking attribute can be accessed for performing unified ranking using a machine-learning-based boost model in accordance with embodiment described herein.

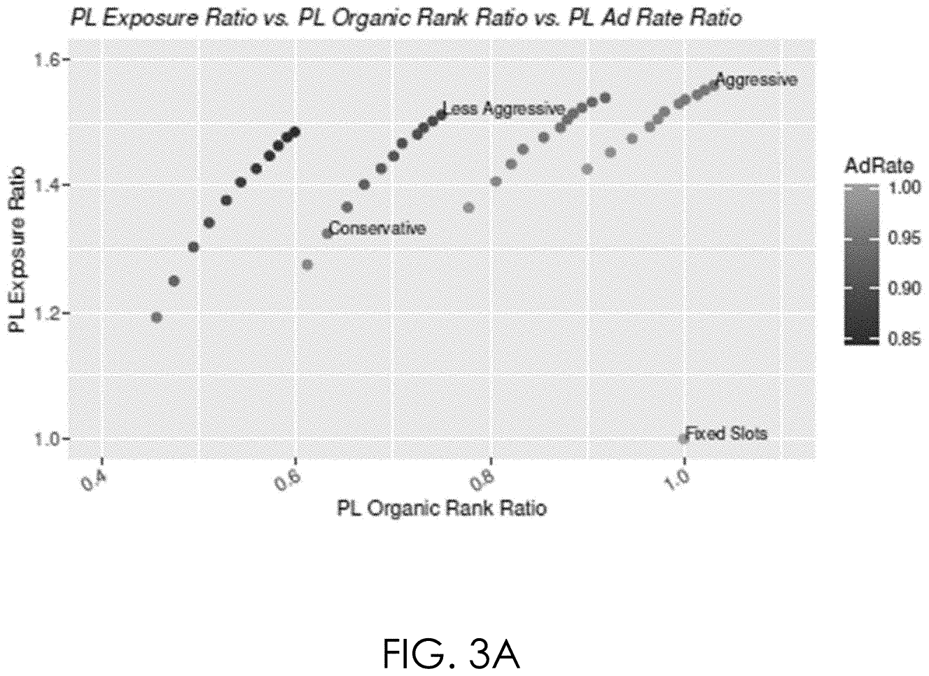

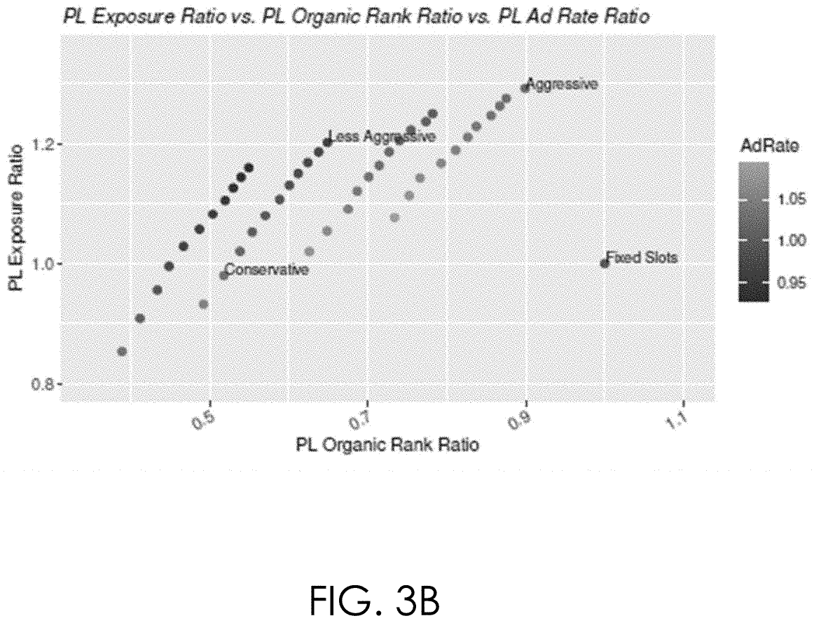

With reference to FIGS. 3A and 3B, FIGS. 3A and 3B are illustrations of example unified ranking machine learning methodology results for the unified ranking engine 120. As discussed, the unified ranking engine can assign a score to each item (organic listing and promoted listing) and ranks them using that single unified ranking score (ur_score). The scoring can be calibrated using the machine learning to balance the trade-off between seller and buyer experience, and take into consideration multiple optimization goals, including relevance, quality, conversion and revenue. In particular, an existing ranker (e.g., Best Match ranker) can already support targeting multiple ranking attributes, as such, the existing ranker can be used in combination with the user-configured ranking attribute to support ranking. In one embodiment, the Best Match ranker score (bm_score) may be for organic listings. The promoted listings get the same score, except for an additional boost. The final unified ranking score for a query q and item i takes the form:

ur_score(q, i)=bm_score(q, i)·f (q, i).

Here f is a function that provides a boost for promoted listings. In some embodiments, f depends on the ad rate only: f (q, i)=f (ad_rate) and f is referred to as the ad rate boost. f can have a general form but can be configured such that f satisfies the two properties below: f (0)=1. Organic listings have an ad rate of 0 and should get no boost. F needs to be monotonic non-decreasing—the higher the ad rate the higher the boost should be. Given the general form of the unified ranking score (2) the main question is how to choose f. The boost model can be calibrated to optimize targets depend on short term and long term business goals and desired user experience. In operation, offline training operations (e.g., “offline simulation”, a combination of offline training and online metrics) are used for training the boost model to choose one “best” ranker. For example, the boost model can be calibrated specifically for any of the following: better quality of promoted listings and a higher interaction rate with them; better overall user experience as measured by overall clicks; conversions, and GMB; and a higher revenue from promoted listings.

In one embodiment the unified ranking engine supports a linear function for f :

$$f ( ad\_rate ) = \{ \begin{matrix}α \cdot ad\_rate + β & ( ad\_rate > 0 ) \\ 1 & ( ad\_rate = 0 )\end{matrix}$$

The ad rate is in percentage unit. For example, boost of 1% ad rate is (α+β). In this linear function f there are two parameters to tune, the slope α and the intercept β. β determines the minimum boost a promoted listing can get when compared to an organic listing. And α decides the marginal boost of a promoted listing with one extra percent ad rate. During the calibration phase, the parameter space online can be evaluated through A/B tests to determine the variant that results in an optimal combination of metrics.

In addition, offline simulation can be performed to simulate the unified ranking experience offline and use offline metrics to choose a few candidate variants for an A/B test. The final “best” variant can be identified using online metrics. It is contemplated that offline metrics can be used to guide us to online improvements. Offline metrics which are easily measurable and highly correlated with targeted online metrics (i.e., GMB, revenue, bought items and other user engagement metrics). The offline metrics can include but are not limited to the following: (1) Average organic rank of promoted listings in top 5 slots. This is the rank that the promoted listings would have got if they were not promoted. Since the Best Match score can be optimized at least in part for quality and relevance of items this metric is a great proxy for the quality or “goodness” of promoted listings. This ranked may need to be improved compared to the baseline to get a better quality for promoted listings. (2) Average exposure of promoted listings in top 5. This exposure metric is calculated by dividing number of promoted listings shown by total number of listings in top 5. The metric can be highly correlated with promoted listings revenue and metric may be increased. (3) Average ad rate for promoted listings in top 5. This metric can be highly correlated with promoted listings revenue. With improved quality some small decrease may occur here but the calibration process can keep the change as small as possible.

In operation, by way of example, two query sets may be identified for offline experiments and each of them has 3000 queries. One has top frequent queries and the other has random queries. While the random query set is a more fair representation of overall traffic, the offline training operations have demonstrated that it is also valuable to look at metrics on top query set since promoted listings are more populated in these frequent queries. A set of top 500 organic listings is identified using production Best Match ranker and top 500 promoted listings using production PL ranker at that time. For each item in the dataset, we collect its best match score and ad rate. The offline training operations further include implementing an ad rate boost function f and simulate the ranking experience with a set of ad rate boost functions. The offline training operations further generate proposed offline metrics. The offline training operations also simulate fixed slots of promoted listings which was the production experience at that time as the baseline.

As shown in FIG. 3A (Offline simulation on top 5 items in top 3k queries—values are relative to the baseline (fixed slots)) and 3B (Offline simulation of top 5 items in random 3k queries—values are relative to the baseline (fixed slots)). By way of example, top 3K queries, offline metrics of average promoted listing (PL) exposure vs. average organic rank of PL vs. average PL ad rate on two query sets in FIG. 3A top frequent 3k queries, and FIG. 3B random 3k queries. Value are relative to the baseline (fixed slots). The offline training operation include 45 ad rate boost functions offline (including baseline). Offline metrics in as shown in FIGS. 3A and 3B show exposure ratio vs. PL organic rank ratio vs. PL ad rate ratio for each variant compared to baseline experience.

As discussed, one optimization of the offline training operations can be to improve PL organic rank and PL exposure while keeping PL ad rate relatively unchanged. If a variant results in improvement in PL exposure against baseline, it should have PL exposure ratio larger than 1. But for PL organic rank, since we prefer higher rank (higher slot in SRP but smaller number in rank), we aim to have PL organic rank ratio less than 1 when compared to baseline (i.e., if a variant improves PL organic rank from 100 to 50, the ratio would be 50/100, which is 0.5). Therefore in FIGS. 3A and 3B the offline training operation can opt to have variant points moving north west from the baseline point. And there are multiple variants which achieve significant improvement on these two metrics on both top 3k queries and US random 3k queries. Out of all ad rate boost functions offline training operations simulate, 3 variants are selected to A/B test and are referred to as Aggressive, Less Aggressive, and Conservative variants. They have different slopes a in the ad rate boost function f with α_{aggressive}>α_{less_aggressive}>α_{conservative}. Therefore, with every extra 1% ad rate a seller pays, the aggressive variant gives the most marginal boost, followed by the less aggressive variant, and the conservative variant.

In one implementation of offline training operations, offline metrics on top 3k queries for the3 A/B test variants can demonstrate that the aggressive variant increases PL exposure the most by 55.87% but it has a relatively small impact on PL organic rank. The less aggressive variant also increases PL exposure by more than 50% and in the meantime it improves PL organic rank significantly by 25.04%. The conservative variant improves PL organic rank the most by 36.78% and it also significantly increases PL exposure by 32.48%. Average ad rate changes are relatively small compared to PL organic rank and PL exposure changes.

Additionally, offline metrics on random 3k queries for the 3 A/B test variants can demonstrate results similar to results on top 3k queries, the aggressive variant achieves highest PL exposure improvement, followed by the less aggressive variant and the conservative variant. The conservative variant increases the organic rank the most, followed by the less aggressive variant and the aggressive variant. Average ad rate changes are relatively small. When comparing results on top 3k queries with random 3k queries, it is determined that for each variant, the PL exposure improvements are relatively bigger on top 3k queries while the PL organic rank improvements are relatively smaller. This implies for different queries, the desired number of promoted listings to show and where to show them can be different.

In another implementation, the 3 variants have been tested online (i.e., live traffic), demonstrating improved PL revenue significantly and the aggressive variant has the largest increase followed by the less aggressive variant, and then the conservative variant. On the other hand, the conservative variant has the best performance in GMB and bought items. It has improved both GMB and bought items significantly. The less aggressive variant has also significantly improved GMB with a neutral impact on bought items. The aggressive variant has neutral impact on both GMB and bought items. Regarding user engagement metrics, the conservative, less aggressive and aggressive variants have improved SRP to VI (view item page conversion rate) significantly by and they have decreased SRP exit rate. Based on the positive online test results, an improved item listing platform can be implemented based on the unified ranking engine.

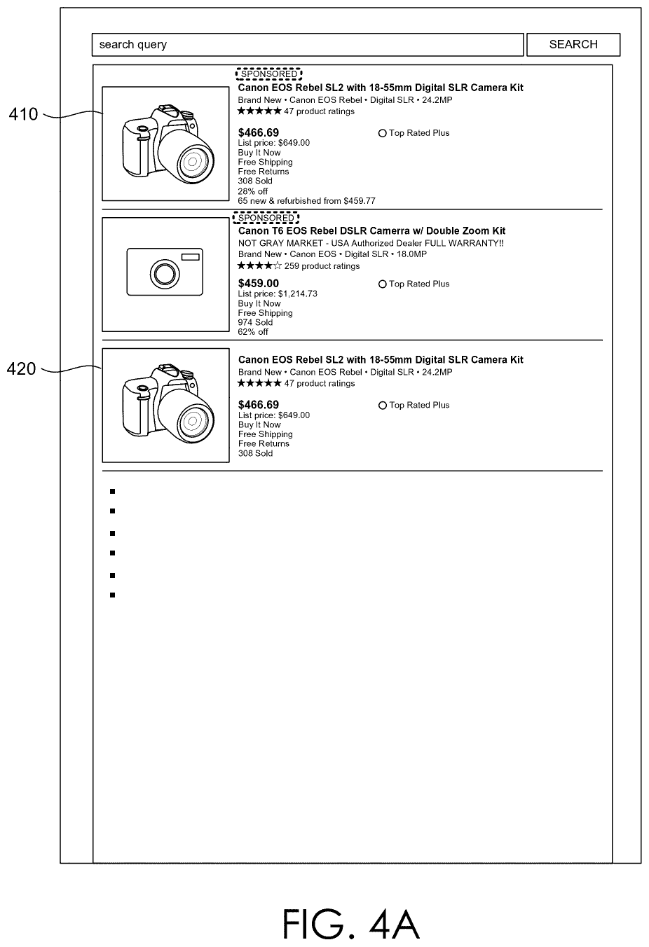

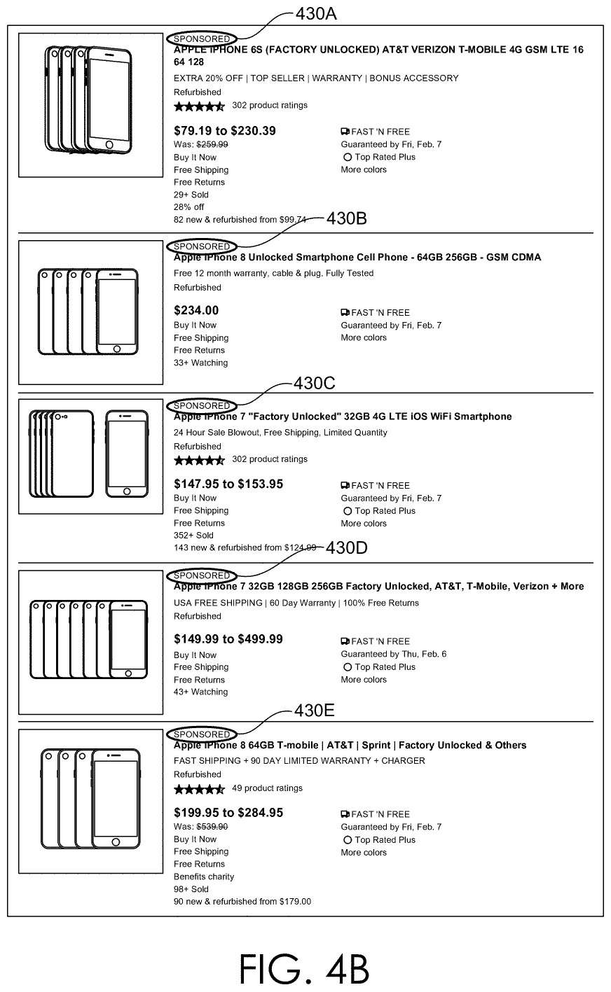

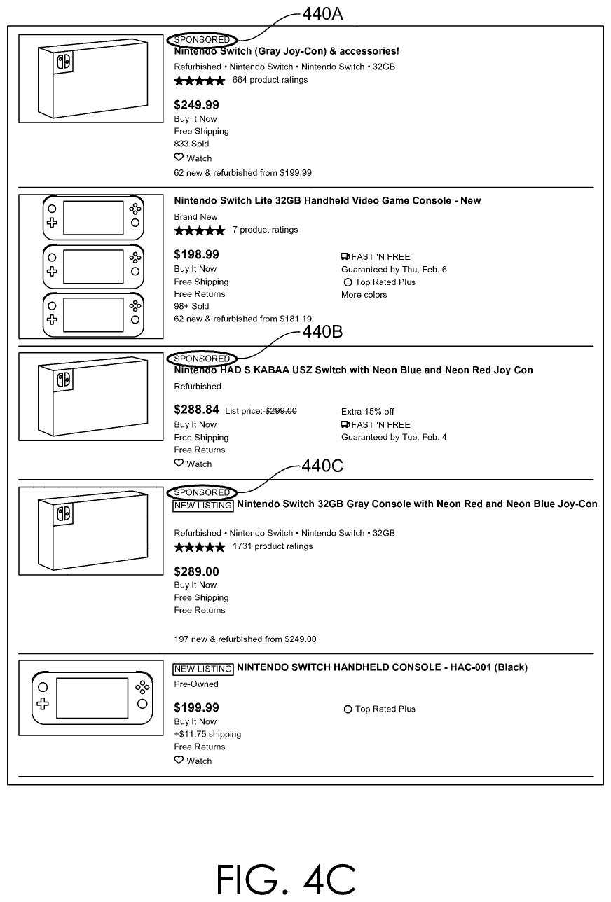

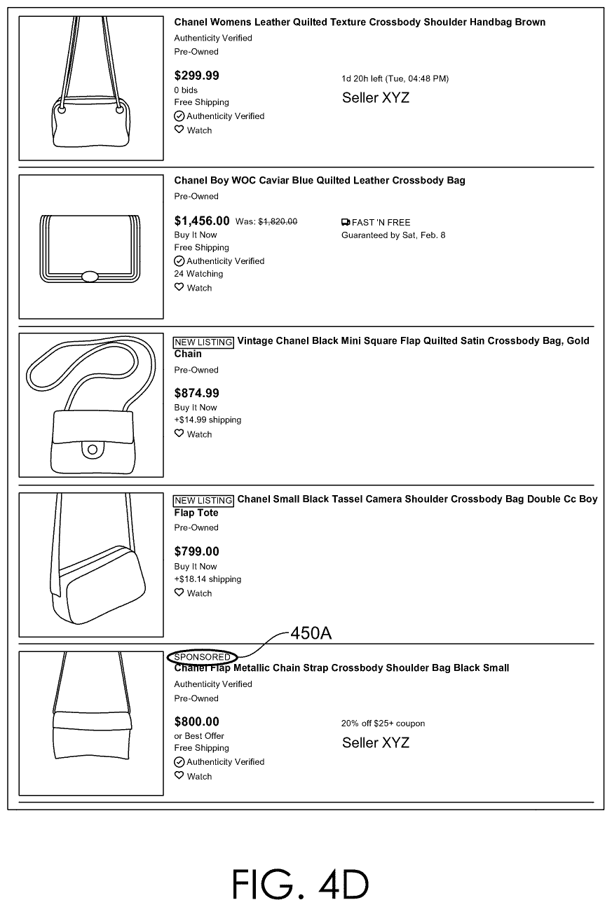

With reference to FIGS. 4A, and 4B-4D, each figure illustrates unified ranking experiences that are caused to be displayed on search result pages. As discussed herein, item listings in the ranked search result items are duplicated in that an item listing is identified as a promoted listing and also as an organic listing on the same search results page. An item listing platform that provides duplicate search result items limits the efficient operation of the item listing platform interfaces and the user experience. FIG. 4A illustrates a search results page that includes item listing 410 “promoted listing” and item listing 420 “organic listing” as duplicates of each other. With the unified ranking engine functionality described herein, FIG. 4B illustrates a search results page for “iphone” as a query with all top 5 slots having non-duplicated sponsored items (i.e., 430A, 430B, 430C, 440D, 440E). FIG. 4C illustrates a search results page for “nintendo switch” as the query with 3 slots having non-duplicated sponsored items (i.e., 440A, 440B, and 440C). FIG. 4D illustrates a search results page for “chanel crosbody” as the query with 1 having a non-duplicated sponsored item (i.e., 450A). As such, with the unified ranking engine 120, the search results page can show a different number of “sponsored” listings (promoted listings) (e.g., all top 5 slots are sponsors, some of the top 5 slots are sponsored, none of the top 5 slots are sponsored) without duplicate listings of organic listings and promoted listings.

### Example Methods for Providing Unified Ranking Operations

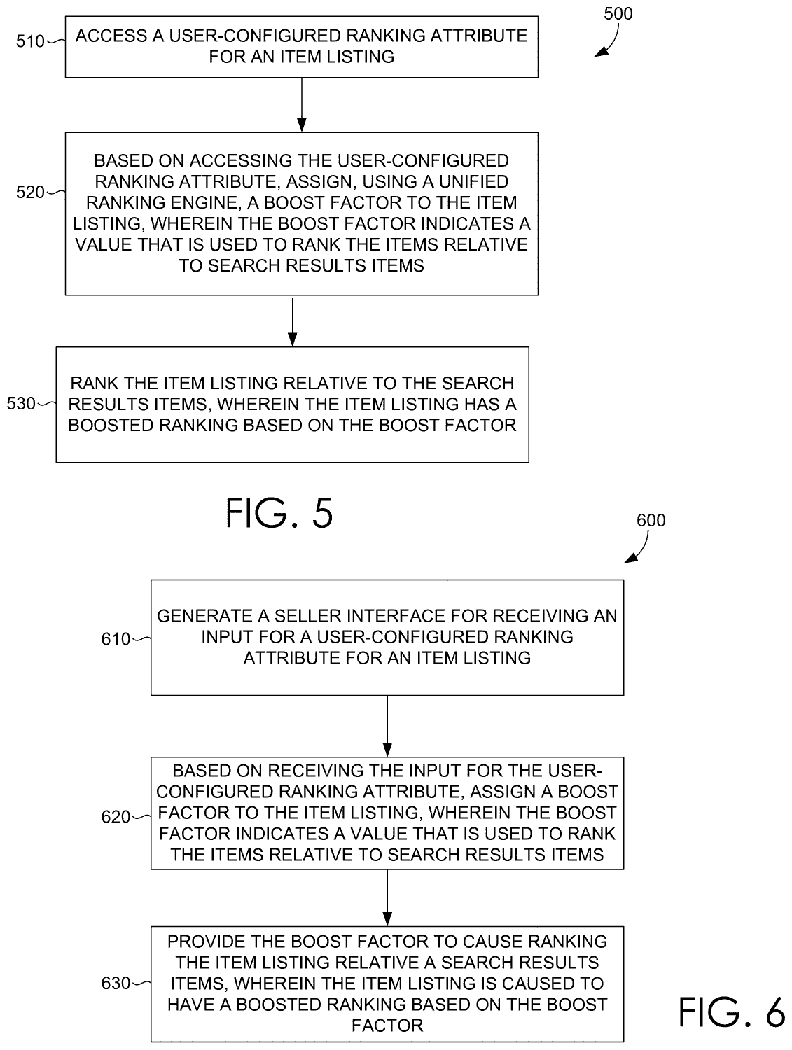

With reference to FIG. 5 and FIG. 6, flow diagrams are provided illustrating methods for providing unified ranking operations for an item listing platform. The methods may be performed using the item listing platform environment described herein. In embodiments, one or more computer storage media having computer-executable instructions embodied thereon that, when executed, by one or more processors can cause the one or more processors to perform the methods in the item listing platform.

Turning to FIG. 5, a flow diagram is provided that illustrates a method 500 for providing unified ranking operations. Initially, at block 510, a user-configured ranking attribute for an item listing is accessed. The user-configured ranking attribute is a promoted-listing ad rate, a first set of item listings are promoted listings associated with promoted-listing ad rates and a second set of item listings are organic listings associated with no ad rates. The user-configured ranking attribute is received as part of a seller listing interface for listing an item associated with the item listing for sale on an item listing platform.

At block 520, based on accessing the user-configured ranking attribute, assign, using a unified ranking engine, a boost factor to the item listing. The boost factor indicates a value that is used to rank the item listing relative to search result items. The boost factor is a parameter in a machine learning ranking model that increases rankings of promoted listing items based on corresponding values of the boost factor. Generating the machine learning model is based on offline simulation of ranking of search result items associated with training data.

At block 530, based on the boost factor, the item listing is ranked relative to the search result items. The item listing has a boosted ranking based on the boost factor. Ranking the item listing is based on a single ranker of the unified ranking engine that supports ranking based on listing-quality ranking attributes in combination with the user-configured ranking attribute. The search result items further include a first set of item listings including the item listing associated with user-configured ranking attributes and a second set of item listings not associated with user-configured ranking attributes. The first set of item listings have boosted rankings based on their corresponding boost factors. Ranking the search result items using boost factors removes duplicates in the ranked search result items, wherein the item listing is identified exclusively as a promoted listing.

Turning to FIG. 6, a flow diagram is provided that illustrates a method 600 providing unified ranking operations. Initially, at block 610, a seller interface is generated for receiving an input for a user-configured ranking attribute for an item listing. At block 620, based on receiving the input for the user-configured ranking attribute, assign a boost factor to the item listing. The boost factor indicates a value that is used to rank the item listing relative to search result items. At block 630, the boost factor is provided to cause ranking the item listing relative to the search result items. The item listing is caused to have a boosted ranking based on the boost factor.

### Example Operating Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present invention.

By way of example, the technical solution system can include an API library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
one or more computer computer-storage media storing computer-useable instructions that, when used by the one or more computer processors, cause the one or more computer processors to perform operations comprising:
accessing a user-configured ranking attribute for an item listing;
based on accessing the user-configured ranking attribute, assigning, using a unified ranking engine, a boost factor to the item listing, wherein the boost factor indicates a value that is used to rank the item listing relative to search result items; and
ranking the item listing relative to the search result items, wherein the item listing has a boosted ranking based on the boost factor.

2. The system of claim 1, wherein the user-configured ranking attribute is a promoted-listing ad rate, wherein a first set of item listings are promoted listings associated with promoted-listing ad rates and a second set of item listings are organic listings associated with no ad rate.

3. The system of claim 1, wherein the user-configured ranking attribute is received as part of a seller listing interface for listing an item associated with the item listing for sale on an item listing platform.

4. The system of claim 1, wherein the boost factor is a parameter in a machine learning ranking model that increases rankings of promoted listing items based on corresponding values of the boost factor, wherein generating the machine learning model is based on offline simulation of ranking of search result items associated with training data.

5. The system of claim 1, wherein ranking the item listing is based on a single ranker of the unified ranking engine that supports ranking based on listing-quality ranking attributes in combination with the user-configured ranking attribute.

6. The system of claim 1, wherein the search result items further include a first set of item listings including the item listing associated with user-configured ranking attributes and a second set of item listings not associated with user-configured ranking attributes, wherein the first set of item listings have boosted rankings based on their corresponding boost factors.

7. The system of claim 6, wherein ranking the search result items using boost factors removes duplicates in the ranked search result items, wherein the item listing is identified exclusively as a promoted listing.

8. One or more computer-storage media having computer-executable instructions embodied thereon that, when executed by a computing system having a processor and memory, cause the processor to:
access a user-configured ranking attribute for an item listing;
based on accessing the user-configured ranking attribute, assign, using a unified ranking engine, a boost factor to the item listing, wherein the boost factor indicates a value that is used to rank the items listing relative to search result items; and
rank the item listing relative to the search result items, wherein the item listing has a boosted ranking based on the boost factor.

9. The media of claim 8, wherein the user-configured ranking is a promoted- listing ad rate, wherein the first set of item listings are promoted listings associated with promoted-listing ad rates and the second set of item listings are organic listings associated with no ad rated.

10. The media of claim 8, wherein the user-configured ranking attribute is received as part of a seller listing interface for listing an item associated with the item listing for sale on an item listing platform.

11. The media of claim 8, wherein the boost factor is a parameter in a machine learning ranking model that increases rankings of promoted listing items based on corresponding values of the boost factor, wherein generating the machine learning model is based on offline simulation of ranking of search result items associated with training data.

12. The media of claim 8, wherein ranking the item listing is based on a single ranker of the unified ranking engine that supports ranking based on listing-quality ranking attributes in combination with the user-configured ranking attribute.

13. The media of claim 8, wherein the search result items further include a first set of item listings including the item listing associated with user-configured ranking attributes and a second set of item listings not associated with user-configured ranking attributes, wherein the first set of item listings have boosted rankings based on their corresponding boost factors.

14. The media of claim 13, wherein ranking the search result items using boost factors removes duplicates in the ranked search result items, wherein the item listing is identified exclusively as a promoted listing.

15. A computer-implemented, the method comprising:
accessing a user-configured ranking attribute for an item listing;
based on accessing the user-configured ranking attribute, assigning, using a unified ranking engine, a boost factor to the item listing, wherein the boost factor indicates a value that is used to rank the items listing relative to search result items; and
ranking the item listing relative to the search result items, wherein the item listing has a boosted ranking based on the boost factor.

16. The method of claim 15, wherein the user-configured ranking is a promoted-listing ad rate, wherein the first set of item listings are promoted listings associated with promoted-listing ad rates and the second set of item listings are organic listings associated with no ad rate,

17. The method of claim 15, wherein the user-configured ranking attribute is received as part of a seller listing interface for listing an item associated with the item listing for sale on an item listing platform.

18. The method of claim 15, wherein ranking the item listing is based on a single ranker of the unified ranking engine that supports ranking based on listing-quality ranking attributes in combination with the user-configured ranking attribute.

19. The method of claim 15, wherein the search result items further include a first set of item listings including the item listing associated with user-configured ranking attributes and a second set of item listings not associated with user-configured ranking attributes, wherein the first set of item listings have boosted rankings based on their corresponding boost factors.

20. The method of claim 19, wherein ranking the search result items using boost factors removes duplicates in the ranked search result items, wherein the item listing is identified exclusively as a promoted listing.
